(19) United States
(12) Patent Application Publication
(10) Pub. No.: US 2006/0207846 A1
(43) Pub. Date: Sep. 21, 2006

(54) Pneumatic spring/damper unit, especially for a motor vehicle

(76) Inventor: Hans-Peter Krauss, Garbsen-Frielingen (DE)

Correspondence Address: CONTINENTAL TEVES, INC., ONE CONTINENTAL DRIVE, AUBURN HILLLS, MI, 48326-1581, US

(21) Appl. No.: 10/568,988

(22) PCT Filed: Jun. 23, 2004
(86) PCT No.: PCT/EP04/51206

§ 371 Date: Feb. 21, 2006

(30) Foreign Application Priority Data
Aug. 22, 2003 (DE) 103 38 939.3

(51) Int. Cl. F16F 9/04

(52) U.S. Cl. 188/314; 188/298; 267/64.23

(57) ABSTRACT

Generic spring/damper units are either too big or require too much mounting space or have only relatively small spring/damper compartments and are therefore not sufficiently efficient. To improve the ratio between the overall size of a spring/damper unit and the size of the damper or spring/damper compartments of the spring/damper unit, the overflow throttles (21, 22) are arranged in the cylinder housing (1) between the damper compartment (10) that is increased in size during spring compression and the spring compartment (17) that is reduced in size during spring compression, thereby reducing the dimensions of the separating piston (6) and the piston rod (7) and making the overflow throttles (21, 22) more accessible from the exterior.

### BACKGROUND OF THE INVENTION

The invention relates to a pneumatic spring/damper unit, in particular for a motor vehicle, comprising a cylinder housing and a double-acting separator piston which is fitted into the cylinder housing and has a piston rod which projects out of the cylinder housing, the cylinder housing and the piston rod each being attached to a respective one of two moveable components and the separator piston dividing the interior of the cylinder housing into one damper space which decreases in size during compression and one further damper space which increases in size during compression and a rolling bellows being fastened in between the projecting piston rod and the cylinder housing, said rolling bellows forming a spring space which decreases in size during compression, the spring space and the damper space being combined by means of ducts in the piston rod into a common spring/damper space, and the common spring/damper space and the damper space being connected by means of overflow throttles.

Spring/damper units of this type are primarily used in the automotive industry.

Pneumatic spring/damper units of this type fundamentally comprise a cylindrical housing and a double-acting separator piston having a piston rod which projects out of the cylindrical housing. The cylindrical housing and the projecting piston rod are respectively fixedly connected to the vehicle structure and to the wheel suspension of a vehicle. The projecting part of the piston rod is covered by a rolling bellows which is fastened both to the cylindrical housing and to the head of the piston rod and forms an enclosed spring space.

The separator piston and the piston rod are equipped with sealing elements which divide the inner space of the cylindrical housing into one damper space which decreases in size during compression and one damper space which increases in size during compression. The damper space which decreases in size during compression is generally connected, by means of a duct situated in the piston rod, to the spring space which is enclosed by the rolling bellows, so that a combined spring/damper space is formed.

The spring/damper unit is connected by means of an inlet line connection to an air supply system which keeps the pressure level of the enclosed air constant at a predetermined value. Corresponding overflow throttles are situated in the separator piston to equalize the air quantities between the spring/damper space which decreases in size during compression and the damper space which increases in size during compression in the event of an externally acting force. Said overflow throttles are designed to act in both directions, said overflow throttles being designed in one direction as a compression stage having a relatively high throughflow resistance and in the other direction as a rebound stage having a relatively low throughflow resistance.

DE 38 24 932 C1 discloses overflow throttles which are designed as open throttle bores having a predetermined throughflow resistance in each throughflow direction. These overflow throttles are constant throttles, which results in the disadvantage that said spring/damper unit has only a limited range of application.

DE-U 84 13 300.7 discloses a spring-loaded overflow throttle in which a duct which passes through the separator piston is covered by at least two spring washers made from sheet steel. Here, the spring washers are mounted outwardly at one side of the separator piston and inwardly at the other side of the separator piston, so that in one direction, the inner diameters of the spring washers lift off from their bearing support, and in the other direction, the outer diameters of the spring washers lift off from their bearing support. The different throughflow resistances are realized in this way. A particular damping characteristic can be obtained through suitable selection of spring strengths, though said damping characteristic is again only tailored to one particular application. Adaptation to other applications requires the spring washers to be exchanged or the preload of the spring washers to be adjusted. The replacement process is highly complex and additional technical equipment is required to adjust the preload of the spring washers.

DE 44 18 120 A1 then proposes an adjustable overflow throttle in which the mechanical spring forces of the spring washers are assisted by magnetic forces. These magnetic forces are generated by an electromagnet in the separator piston which is powered and controlled externally by means of suitable lines. The damping forces acting at the overflow throttle are thus adapted to the current loading situation.

These spring-loaded overflow throttles, and in particular the adjustable overflow throttles, are disadvantageous firstly because they are highly susceptible to failure. This is because the overflow throttles are accommodated in the separator piston, and if, in its installation position, the spring/damper unit is fastened by means of its piston rod to the wheel suspension of the vehicle, then this separator piston is subjected to the high axle accelerations of the vehicle. The vibrations which are thus externally introduced into the spring/damper unit affect the functioning of the spring washers and thus distort the desired damping characteristic.

A significant disadvantage is, however, that in this type of spring/damper unit, the separator piston must be designed to be very large because the overflow throttles with their closing elements and with the electromagnet require a relatively large amount of space. The piston rod must also be designed to be very large since the power and control elements for actuating the overflow throttles must be guided out through the interior of the separator piston. This over-dimensioning of the separator piston and of the piston rod and the complicated structure of the separator piston and of the piston rod make the spring/damper unit both complex and expensive to produce.

However, said over-dimensioning of the separator piston and of the piston rod also results in the spring/damper unit being of a size that prevents it being used in a limited installation space. The over-dimensioning of the separator piston and of the piston rod can however also be carried out inwardly if the outer dimensions of the spring/damper unit are predefined. The over-dimensioning then leads to the damper space or spring/damper space being reduced in size and thus to a reduction in performance of the spring/damper unit.

However, said over-dimensioning is also associated with an increase in mass of the separator piston and of the piston rod, and this is always disadvantageous if the moving masses of the separator piston and of the piston rod are subjected to the axle accelerations as a result of a corresponding installation position of the spring/damper unit.

It is therefore the object of the invention to improve the ratio between the outer dimensions of a generic spring/damper unit and the size of the spring and pressure spaces of the spring/damper unit.

### SUMMARY OF THE INVENTION

This object is achieved in a spring damper of the above-mentioned kind in that the overflow throttles are arranged in the cylinder housing between the damper space which increases in size during compression and the spring space which decreases in size during compression The new spring/damper unit improves the discussed disadvantages of the prior art.

In this case, it is particularly advantageous that the spring/damper unit is of small size because the separator piston and the piston rod can be kept very thin. This saves installation space and/or increases the volumes of the spring spaces and damper spaces. In addition, the smaller dimensioning reduces the masses of the separator piston and of the piston rod, which has a positive effect on the damping behavior.

In addition, the arrangement of the overflow throttles in the cylinder housing can be realized both technically and economically using simple means, because the new position of the overflow throttles is more easily accessible from the exterior and is thus easier to arrange. However, the improved accessibility not only results in simplified production but also advantageously permits required conversion to a different spring characteristic.

With the spring/damper unit in a normal installation position, the arrangement of the overflow throttles in the cylinder housing also isolates the overflow throttles from the vibrations which originate from the axle, which has a positive effect on the damping behavior.

It is also expedient if, in addition to the overflow throttles, further throttle elements are provided in or on the piston rod, the throttle cross sections being adjusted as a function of the stroke of the piston rod. In this way, additional damping forces can be generated utilizing stronger flows within the piston rod.

The invention is to be explained in more detail on the basis of an exemplary embodiment.

### BRIEF DESCRIPTION OF THE DRAWING

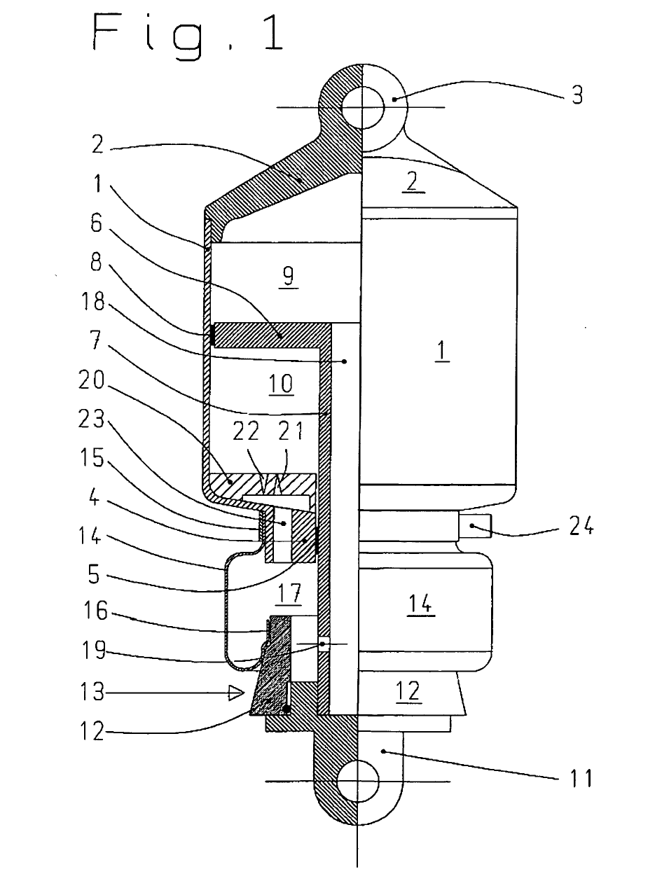

For this purpose, FIG. 1 shows a spring/damper unit in a half section.

### DETAILED DESCRIPTION OF THE DRAWING

According to FIG. 1, and in a known manner, the pneumatic spring/damper unit comprises a cylinder housing 1, which at one side is closed off in a pressure-tight manner by means of a cylinder cover 2. This cylinder cover 2 has a fastening element 3 for mounting it, for example, on the structure of a vehicle. A collar 4 of narrowed cross section which has a through bore is integrally formed on the opposite side of the cylinder housing 1 from the cylinder cover 2. A sliding and sealing element 5 is situated in the through bore of the collar 4. A double-acting separator piston 6, having a piston rod 7, is fitted with play into the inside of the cylinder housing 1, the separator piston 6 being equipped at its circumference with a sliding and sealing element 8, and the piston rod 7 passing through the through bore of the collar 4. In this way, a damper space 9 which decreases in size during compression of the separator piston 6 is formed at the piston side of the separator piston 6, and a damper space 10 which increases in size during compression of the separator piston 6 is formed at the piston rod side of the separator piston 6. At its projecting end, the piston rod 7 has a fastening element 11 for mounting the spring/damper unit for example on the wheel suspension of the vehicle. A rolling piston 12, having an outer rolling face 13 for a rolling bellows 14, is fixedly connected to the fastening element 11 and thus to the piston rod 7. Said rolling bellows 14 is fixedly fastened in a pressure-tight manner both to the collar 4 of the cylinder housing 1 by means of a first fastening sleeve 15, and to the end of the rolling piston 12 closest to the cylinder housing by means of a second fastening sleeve 16. A spring space 17 which decreases in size during compression of the separator piston 6 is thus formed between the piston rod 7 and the rolling bellows 14.

The damper space 9, the damper space 10 and the spring space 17 are now connected to one another in a particular way. The piston rod 7 has an axial through bore 18 and, in the region of the spring space 17, a radial bore 19, which together combine the spring space 17 which decreases in size during compression and the damper space 9 which decreases in size during compression into a uniformly-acting spring and damper space.

In the region of its collar 4, the cylinder housing 1 has a valve insert 20 which is fixedly seated in the cylinder housing 1 and which is equipped with an overflow throttle 21, which comprises a plurality of openings, for the compression stage, and an overflow throttle 22, which likewise comprises a plurality of openings, for the rebound stage. These two overflow throttles 21, 22, together with a connecting duct 23 situated in the collar 4 of the cylinder housing 1, connect the spring space 17, and thus also the damper space 9 which decreases in size during compression, to the damper space 10 which increases in size during compression.

The overflow throttles 21, 22 are formed here in a conventional manner as throttle bores of constant cross section, as spring-loaded throttle elements having a constant or adjustable spring characteristic. The corresponding devices for powering and controlling the throttle elements of the overflow throttles 21, 22 are situated outside the spring/damper unit and are connected to the overflow throttles 21, 22 by means of an adapter 24 which is arranged on the collar 4 of the cylinder housing 1 and is illustrated symbolically.

The mode of operation of a spring/damper unit of this type is sufficiently known and will therefore only be described briefly. A closed air supply system constantly maintains an air pressure of a selected pressure level in the interior of the spring/damper unit. External loading of the spring/damper unit tends to push the separator piston 6 into the cylinder housing 1. This movement is opposed by a force which results from the air pressure in the interior of the spring/damper unit and the difference between the areas of the two faces on the separator piston 6. This opposing force keeps the separator piston 6 in its position and thus maintains the desired clearance between the wheel suspension and the vehicle structure. The desired spring effect results here from the compressibility of the enclosed air. Within the context of this compressibility, the separator piston 6 performs oscillating movements in which the enclosed air is displaced from the damping chamber which is decreasing in size into the damping chamber which is increasing in size via the overflow throttles 21, 22. Here, damping forces are generated at the overflow throttles 21, 22, which damping forces oppose the compressing movement of the separator piston 6.

### LIST OF REFERENCE SYMBOLS

1 Cylinder housing
2 Cylinder cover
3 Fastening element of the cylinder housing
4 Collar
5 Sliding and sealing element of the cylinder housing
6 Separator piston
7 Piston rod
8 Sliding and sealing element of the separator piston
9 Damper space which decreases in size during compression
10 Damper space which increases in size during compression
11 Fastening element of the piston rod
12 Rolling piston
13 Rolling face
14 Rolling bellows
15 First fastening sleeve
16 Second fastening sleeve
17 Spring space which decreases in size during compression
18 Axial through bore
19 Radial bore
20 Valve insert
21 Overflow throttle for the compression stage
22 Overflow throttle for the rebound stage
23 Connecting duct
24 Adapter

1-4. (canceled)

5. A pneumatic spring/damper unit, comprising a cylinder housing (1) and a double-acting separator piston (6) which is fitted into the cylinder housing (1) and having a piston rod (7) which projects out of the cylinder housing (1), the cylinder housing (1) and the piston rod (7) each being attached to a respective one of two moveable components and the separator piston (6) dividing the interior of the cylinder housing (1) into a first damper space (9) which decreases in size during compression and a second damper space (10) which increases in size during compression, and a rolling bellows (14) being fastened in between the projecting piston rod (7) and the cylinder housing (1), said rolling bellows (14) forming a spring space (17) which decreases in size during compression, the spring space (17) and the first damper space (9) being combined by means of ducts in the piston rod (7) into a common spring/damper space (9, 17), and the common spring/damper space (9, 17) and the second damper space (10) being connected by means of overflow throttles (21, 22),
wherein the overflow throttles (21, 22) are arranged in the cylinder housing (1) between the second damper space (10) which increases in size during compression and the spring space (17) which decreases in size during compression.

6. The pneumatic spring/damper unit as claimed in claim 5, wherein the cylinder housing (1) has an open connecting duct (23) in the region between the second damper space (10) and the spring space (17), and the overflow throttles (21, 22) are arranged in a valve insert (20) which is fixedly located in the cylinder housing (1).

7. The pneumatic spring/damper unit as claimed in claim 5, the overflow throttles (21, 22) being embodied as spring-loaded throttles with powered throttle elements,
wherein an adapter (24) to connect external devices for powering and controlling the throttle elements of the overflow throttles (21, 22) is arranged on a collar (4) of the cylinder housing (1).

8. The pneumatic spring/damper unit as claimed in claim 7, wherein, in addition to the overflow throttles (21, 22), further throttle elements are provided in or on the piston rod (7), the throttle cross sections being adjusted as a function of the stroke of the piston rod (7).
